(19) United States
(12) Patent Application Publication
(10) Pub. No.: US 2009/0024671 A1
(43) Pub. Date: Jan. 22, 2009

(54) CONTENT MANAGEMENT SYSTEM AND EXTERNAL DATA STORAGE SYSTEM DATA SYNCHRONIZATION

(75) Inventors: David Charles Johnson, Redmond, WA (US); Jad Honein, Redmond, WA (US); Rachna Vargiya, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/165,163

(22) Filed: Jun. 30, 2008

Related U.S. Application Data
(60) Provisional application No. 60/961,180, filed on Jul. 19, 2007.

(51) Int. Cl. G06F 17/30

(52) U.S. Cl. 707/201; 707/E17.005

(57) ABSTRACT

Described is a technology by which a content management system (such as part of Microsoft® Office SharePoint® Server) synchronizes data with an external (e.g., third-party) data storage system. For example, live video and/or on demand video webcasts may be stored on the external data storage system, but may be controlled by events created and edited at the content management system, even though the content management system does not directly support video content. In one example, an administrator creates or modifies an event at the content management system, and if the event is coordinated with the external data storage system, the content management system is synchronized with the external data storage system. One-way communication and/or two-way communication may take place for synchronization, including providing parameters to the content management system from the data store, or by sending notifications and queues to synchronize data with the content management system.

### CROSS-REFERENCE TO RELATED APPLICATION

The present application claims priority to U.S. provisional patent application Ser. No. 60/961,180, filed Jul. 19, 2007 and hereby incorporated by reference.

### BACKGROUND

System administrators of a content management system (CMS) can face challenging tasks in providing rich user experiences for users of the content management system. Administering the content management system may involve setting permissions for accessing different types of data, controlling how data is approved for display to both internal and external users of the content management system, managing how data is stored and organized, and so forth.

Typically, the amount of data stored in the content management system can become large (e.g., on the order of gigabytes/terabytes) and difficult for system administrators to organize and use efficiently in providing a rich user experience. Further, inefficient use of IT resources such as servers, hard drives, and associated administrative support to maintain the large amounts of data can result in excessive costs. Still further, while the content management system may provide a number of features, some of an enterprise's data is not managed by the content management system. As a result, system administrators face a difficult task of easily and efficiently organizing and managing the data stored in the content management system while also providing users of the content management system with a rich user experience.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a content management system (such as part of Microsoft® Office SharePoint® Server) synchronizes data with an external (e.g., third-party) data storage system. For example, an administrator may input data to an event receiver of the content management system to create or modify an event, and if the event is one that is flagged as being coordinated with the external data store, the event receiver synchronizes the content management system with the external data storage system.

One-way communication from the content management system to the data storage system may take place, such as by calling APIs of the data storage system. Two-way communication (between the content management system and the data store) may also take place, including providing parameters to the content management system from the data store for use in various ways, such as to construct a URL. Notifications and queues may be used by the external data storage system to synchronize data with the content management system.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an example block diagram of a content management system and an external data source synchronized therewith.

FIG. 2 is a flow diagram representing an example of steps taken in response to an event corresponding to video being created.

FIG. 3 shows an illustrative example of a computing environment into which various aspects of the present invention may be incorporated.

### DETAILED DESCRIPTION

Described herein is a technology that integrates a content management system/enterprise collaboration tool (e.g., such as provided by Microsoft Corporation's SharePoint® technology) with an external source of content, such as a web service that provides video content, in which the content management system does not have the capabilities of the web service (e.g., does not support video). As will be understood, this allows administrators to leverage the management and other capabilities of the content management system and the storage and other capabilities of the web service. For example, media streaming with optimized network bandwidth may be a feature provided by the web service, but is not a capability supported by the content management system.

While the examples herein are directed towards SharePoint® and an external source of content in the form of a web service that provides video content, it is understood that these are only examples. Any content management system/collaboration program, and/or web service that provides content such as SQL content, may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data management in general.

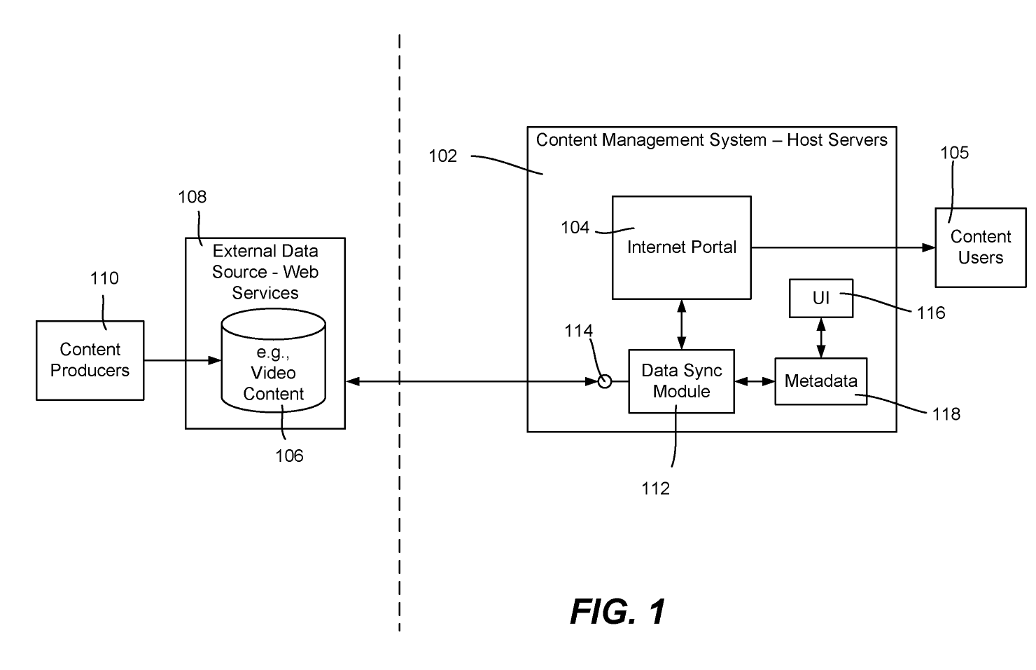

Turning to one example implementation generally represented in FIG. 1, there is shown a content management system 102, such as running on a set of one or more host servers. For example, the content management system may be based upon Microsoft® SharePoint® that provides an internet portal 104 by which corporate and other authorized users 105 can view audiovisual media content 106, such as speeches, seminars, and so forth. However, as will be understood, while the content is managed by the content management system 102 and accessed through the portal 104, the content is typically not maintained there, but rather on an external data source system, represented in FIG. 1 by the external data source/web services 108. Content producers 110 or the like provide the content 106, which may be independent of the management of that content 106.

As represented in FIG. 1, the content management system 102 includes a data synchronization module 112 comprising an interface 114 by which the content is kept synchronized with the content management system 102. The web service 108 may have a similar interface, e.g., a set of APIs. For example, via a user interface 116 or the like, administrators may receive and/or change metadata associated with each piece of content being managed, e.g., the title, time data, speakers, and so forth. For example, administrators may create, update or delete items in a content management system data structure, e.g., list), which is then synchronized with the external data source/web services 108. For example, old content may be deleted, or moved to a different storage location. Note that the technology is smart enough to synchronize from one source to another one without falling into a cyclic non-ending synchronization. Other data structures include document library, custom list, page library, and so forth.

In one example implementation, the technology allows the use of SharePoint's out-of-box features to pull the content from the list and display it on pages of the site (content roll up from the list to pages using CBQ webparts), workflows for content management, integration with an events calendar along with media streaming capabilities from the external data storage system including side by side slideshow, routing to closest servers, and so forth. In general, the technology described herein thus keeps data stored in SharePoint® or any similar program synchronized with data stored in external data stores, whereby various products may use the data while taking advantage of SharePoint®'s or any similar program's capabilities including data roll-up, and its user interfaces 116.

In one example implementation, the technology is implemented as a utility/module that synchronizes the metadata 118 associated with a custom list item or other data structure item in SharePoint® with the external data store/web service 108. This allows users to use to leverage the content management capabilities in Microsoft Office SharePoint® Server and the features provided by (e.g., third party) software using externally stored data. One example implementation facilitates synchronizing SharePoint® custom list data with the external data storage system data store, allowing users to use the data storage system's media streaming features, and providing an integrated media experience within Microsoft Office SharePoint® Server. Note that while synchronizing of media in the form of webcasts and the like are used in the examples, it is understood that any external data store of any content may be synchronized, (possibly in conjunction with some internally/locally stored content). For example, news data may be kept synchronized with an external news data source or other data set, audio data may be kept synchronized, and so forth.

By way of a video content example, the technology thus provides the centralized portal 104 for webcast content and videos. Users are able to browse for videos through various channels; editorial teams may promote previous and upcoming events. For example, the technology may provide browsing functionality for end users through a video catalog, an administration layer to allow editorial staff to upload assets and metadata, a workflow to streamline the content upload and approval process, and extensibility for additional channels that may be added. To this end, there is provided an interface to end users and administrators to browse and achieve event promotion, along with an integrated metadata repository for all streaming and on-demand content, and a scalable server solution to support increased demand for videos.

As described in the aforementioned related application, scenarios include announcements for live events, on-demand viewing, archive requests, calendar functionality, RSS feeds and so forth. Administrator scenarios include upload of an event to the module 112 that handles the synchronization. In general, when a publisher adds metadata to a product, module 112 synchronizes that metadata to the external data source system/web services 108. If any metadata is updated in the product or the external system web services 108, the metadata 112 is automatically synchronized back in the other direction via the module 112.

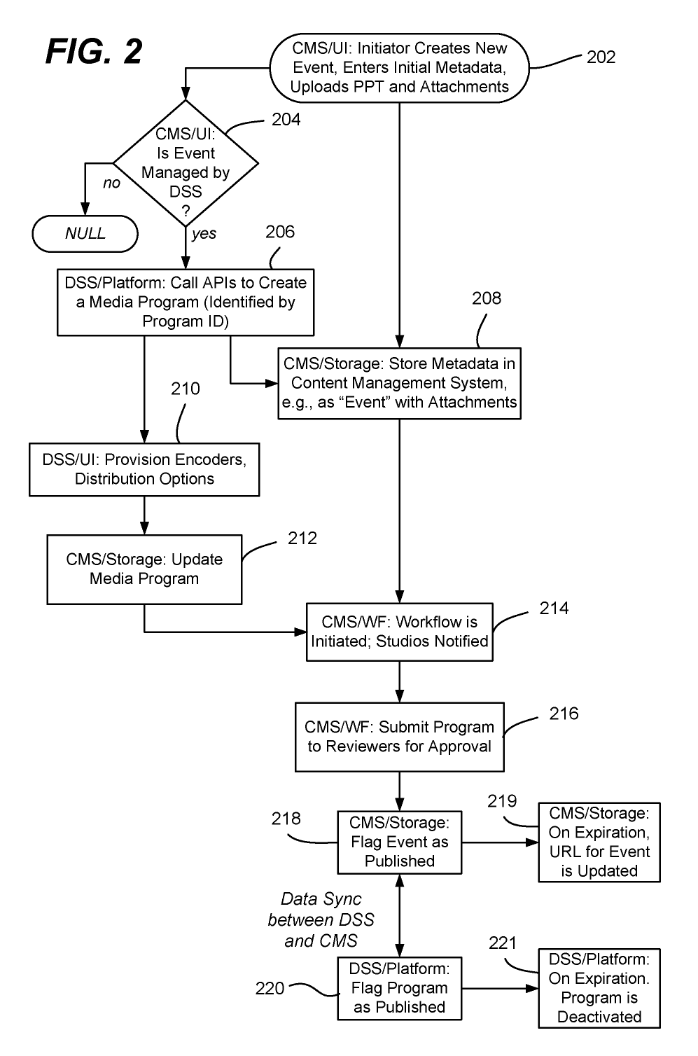

FIG. 2 is an example flow diagram showing various aspects of synchronization and related activities. While the examples of FIG. 2 are for video media content, other content may be substituted. In general, at block 102, an example data flow starts with the creation of an event in a content management system (CMS) data structure, e.g., a SharePoint® list, via the CMS user interface (CMS/UI) 116. The event may have associated parameters; in one example, a flag is checked by the publisher if the event is managed through the external data storage system (DSS), corresponding to the web services 108.

If so, as represented via step 204, step 206 is executed by the DSS platform to call APIs in order to create a media program, with an associated identifier. For example, the flag may cause an event receiver to invoke create/update APIs every time a change is made to the data, including upon creation. These APIs may create/update the event in the external data storage system and return parameters to the content management system via the data synchronization module 112; for example such parameters may identify the respective Program and Content IDs to SharePoint®. Any type of parameter is feasible, e.g., text, XML schema, and so forth.

Once the item is created (and stored, step 208) in the external data storage system, any settings required (e.g., for streaming purposes such as encoders, stations, players) are configured by the technical teams directly in the external data storage system (DSS), as represented via step 210. These settings may be set in the external data store, and because of the two-way synchronization, the content management system will be synchronized to automatically update the corresponding data (metadata) stored therein. The event receiver may generate a URL for the event, such as based on the parameters returned from the external data storage (e.g., identifiers) returned to the content management system. If the event is a not an external data storage system event, the Administrator may manually enter the URL and no APIs are invoked when the item is saved.

As represented in FIG. 1, the content management system initiates a workflow at step 214. This submits a media program (e.g., by sending an email or other notification) at step 214 to an approver who can approve the workflow, thereby publishing the event (steps 218 and 220).

In this example, the event has an associated expiration date and reminder date. On the reminder date, a notification is sent to the content owner indicating that the specific event is going to expire on the expiration date. On the expiration date, the event is deactivated in the external data store (step 220) and therefore in the content management system as well (step 221).

Example Schema in a SharePoint®-Based Content Management System.

### Lists:

The metadata for events is stored in a custom list that supports attachments. For example, this list may be located under XYZW>News & Events>StudioCasts>.

Any content type can be synchronized with a data store if the fields are mapped appropriately. In one example implementation, the list includes two content types: Event and Event Group. These content types derive from the “Item” content type.

Event Content Type:

| Name | Type | Status |
|---|---|---|
| Event Name | Single line of text | Required |
| Description | Rich Text Editor | Optional |
| Event Start Date Time | Date and Time | Optional |
| Event Start Time Integer | Integer (internally | Optional |
| | computed, hidden from | |
| | users) | |
| Event End Date Time | Date and Time | Optional |
| Expiration Date | Date and Time | Optional |
| Reminder Date | Date and Time | |
| | (internally computed, | |
| | hidden from users) | |
| Event URL | Rich Text Editor | |
| | (for multiple urls) | |
| Category | Choice | Optional |
| Group Name | Lookup | Optional |
| Live or video on demand | Choice | Optional |
| Breakfast Series Promo | Choice | |
| Event Location | Single line of text | Optional |
| Event Owner | Single line of text | Optional |
| Speakers | Single line of text | Optional |
| Keywords | Single line of text | Optional |
| Headline | Single line of text | Optional |
| Image Tag | Publishing Image | Optional |
| Related Resources | Multiple lines of text | Optional |
| Content ID(500k) | Single line of text | Optional |
| Content ID(300k) | Single line of text | |
| Program ID | Single line of text | Optional |
| Content Source | Single line of text | Optional |
| Display URL | Yes/No | Optional |
| Hide Item | Yes/No | Optional |
| Promo Description | Single line of text | Optional |
| Promo Spot | Choice | Optional |
| Publish to Event Calendar | Yes/No | Optional |
| EventCalendarId | Single line of text | Optional |
| Permissions | Choice | Optional |
| Managed By the external data | Yes/No | Optional |
| storage system | | |
| Most Watched Events | Choice | Optional |
| Recently Added | Choice | Optional |
| EventCalendarID | | Optional |
| Event Identifier | Single line of text | Optional |
| Video File (500k) | Single line of text | Optional |
| Video File (300k) | Single line of text | Optional |
| Other Associated Files | Multiple lines of text | Optional |
| AttachmentContentIDMapping | Multiple lines of text | Optional |

Event Group Content Type:

| Name | Type | Status |
|---|---|---|
| Title | Single line of text | Required |
| Group Event Name | Single line of text | Optional |
| Description | Rich text editor | Optional |
| Category | Choice | Optional |
| Image Tag | Publishing Image | Optional |
| Recently Added | Choice | Optional |
| Promo Description | Rich text editor | Optional |
| Promo image | Image | Optional |
| Promo title | Single line of text | Optional |
| Event Identifier | Single line of text | Optional |

Considering security, when an event is created, the Administrator enters the security groups and/or users that will have access to view the event. Administrators can check the “Default” checkbox to allow read access to all users. If no checkbox is checked, no end user can view the content. When the event is published, it is viewable only by the users that were granted permissions. To allow the administrators on the list to be able to view/edit the item, they will be granted permissions in addition to the ones selected by the administrator. Only the author of the event is granted full access to the item along with approvers for the list and a pre-specified security group, e.g., consisting of a set of “super broadcasters” for media content.

The item level security is propagated to the external data storage system from the content management system on item creation and update to maintain access control through their interface.

The event receiver triggers required actions when the data structure (e.g., StudioCast list) is modified. The following actions are triggered by the event receiver 104:

On Item Creation:
1) The external data storage system APIs are called to create/update the event in the external data storage system and parameters (e.g., content IDs) are written back to the data structure (e.g., list)
2) Item level security will be applied as described above.
3) If the number of items in existing folders is greater than some value, (e.g., 2,000), a new folder is created and the item is moved to that folder. If not, the item is moved to an existing folder.
4) The Start date time is converted to an integer and in the Start DateTime integer column.
5) The reminder date column is filled with the date one week prior to the expiration date.

### On Item Approval:

1) The item is pushed to the Event calendar list for publishing on item approval.

External data storage system integration: Metadata Storage

The metadata for events resides in the content management system (e.g., SharePoint®) and is replicated to the external data storage system for events managed through the external data storage system. This model of mastering the data in SharePoint® provides the benefit of the rich workflow capabilities in SharePoint®, handles the requirement to support external channels not streamed through the external data storage system, and simplifies Microsoft® Office SharePoint® Server calendar integration.

Because some data is maintained to two systems, they need to be kept synchronized. This is done by ingesting data from the content management system to the external data storage system, and synchronizing data from the external data storage system to the content management system. The external data storage system API calls are made through the Event receiver, described above.

For synchronizing data from the external data storage system to the content management system, changes from the external data storage system are pushed to the content management system using notifications. Notifications may be used for the following scenarios:

Notification for data synchronization:
To keep data between the content management system and the external data storage system synchronized when data in the external data storage system is updated by an administrator.

The following describes example data structure fields that may be associated with an example video-related event:

| Name | Field Description |
|---|---|
| Event Name | Name of the event |
| Description | Description |
| Event Start Date Time | Date and time when the event will occur. Does not |
| | apply to video on demands |
| Event End Date Time | Date and time when event ends. Does not apply to |
| | video on demands |
| Expiration Date | Date and time when the event expires. This is when |
| | the external data storage system deactivates the |
| | program. Administrator also needs to change the URL |
| | for the event to the archive page. |
| Reminder Date | Date when the Administrator wants an email to be sent |
| | to the content owner reminding that the event is about |
| | to expire |
| Event URL | URL for streaming the event (this needs to be manually |
| | filled out for non the external data storage system |
| | managed events only) |
| Category | Channels on which the event will appear. |
| Group Name | If the videos is a part of a larger event and will show up |
| | on the exception page, this field needs to be filled with |
| | the name of |
| Live or video on demand | Type of event. It can be either Live or on demand |
| | video. The third choice is upcoming which is applicable |
| | only for the Breakfast series page where an upcoming |
| | breakfast series needs to be promoted |
| Event Location | Physical location of the event |
| Event Owner | Owner of the event (broadcaster) |
| Speakers | Speakers for the event |
| Keywords | Keywords corresponding to the event. |
| Headline | Headline for the event. This will show up next to the |
| | image above the description on the site |
| Image Tag | Publishing Image |
| Related Resources | Links to related material. Up to 3 links. |
| Content ID | ID for the video/stream in the external data storage |
| | system. This is populated automatically. |
| Program ID | ID for the program in the external data storage system. |
| | This is populated automatically. |
| Content Source | Source of the webcast, e.g. inside track |
| Display URL | Flag to hide the url if it is broken or not functional yet |
| Hide Item | Flag to hide the item from browse |
| Promo Description | Description to appear in the promo spot if the event |
| | needs to be promoted |
| Promo Spot | If the event needs to be promoted, and which spot to |
| | promote it on |
| Publish to Event Calendar | Should the event be published to the Events calendar; |
| | only applicable for live |
| EventCalendarId | Populated automatically to track the event in Event |
| | calendar |
| Permissions | Permission to users to view the item. Can set security |
| | groups or individual aliases. |
| Managed By the external data | Is the event streamed and managed through the |
| storage system | external data storage system. APIs for syncing are |
| | called only if this is marked. |
| Most Watched Events | Should the event be displayed in the most watched |
| | sections on the landing page |
| Recently Added | Should the event be displayed in the recently added |
| | sections on the landing page |
| Event Identifier | Identifier entered by broadcaster to identify the event |
| Video File (500k) | Full path to the video file for 500k stream |
| Video File (300k) | Full path to the video file for 300k stream |
| AttachmentContentIDMapping | Automatically populated by content management |
| | system code when content id is returned for each |
| | attachment to maintain mapping between the |
| | attachments and IDs |
| Other Associated Files | Full path to all supporting documents for the event |
| | separated by semi colon |

### Exemplary Operating Environment

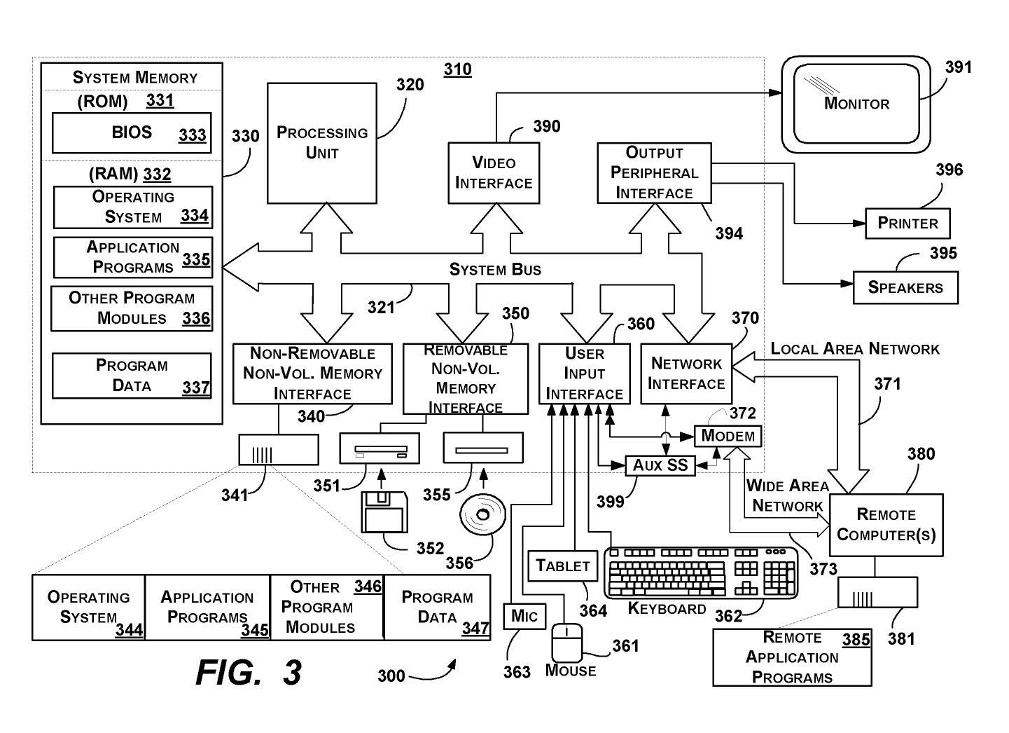

FIG. 3 illustrates an example of a suitable computing and networking environment 300 into which the examples and implementations of any of FIGS. 1 and 2 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component 374 such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method, comprising, maintaining media content at a data storage system, maintaining metadata associated with the media content at a content management system that does not directly support the media content, and synchronizing changes to the metadata at the media content system with corresponding data at the data storage system to provide management of the media content via the content management system and usage of the capabilities of the data storage system for media access.

2. The method of claim 1 wherein synchronizing the changes comprises providing notifications to the data storage system.

3. The method of claim 1 further comprising, receiving data from the data storage system relative to the media content.

4. The method of claim 1 wherein the data received from the data storage system comprises at least one parameter, and further comprising, generating a URL based on the data received from the data storage system.

5. The method of claim 1 wherein the media content comprises video, and wherein synchronizing the metadata comprises providing access to media streaming capabilities provided by the data storage system.

6. The method of claim 1 further comprising, creating an event at the content management system, and publishing a media program corresponding to the event.

7. The method of claim 1 wherein maintaining the metadata comprises accessing a Microsoft® Sharepoint® data structure.

8. The method of claim 1 wherein maintaining the metadata comprises accessing a Microsoft® Sharepoint® list.

9. The method of claim 1 wherein synchronizing the changes comprises expiring the media content.

10. In a computing environment, a system comprising, a content management system that does not provide media streaming capabilities, the content management system including a data synchronization module having an interface by which a source of media content is accessed to use media streaming capabilities thereof, including by providing notifications of changes to metadata corresponding to the media content to the source.

11. The system of claim 10 wherein the interface receives parameters from the source of the media content.

12. The system of claim 10 wherein the content management system is used to manage a portal by which users access the media content.

13. The system of claim 12 wherein the wherein the media content comprises corresponds to live event video, on-demand content, archived content, calendar-related content or an RSS feed.

14. The system of claim 10 wherein the metadata is maintained in a Microsoft® Sharepoint® data structure.

15. The system of claim 10 wherein the metadata is maintained in a accessing a Microsoft® SharePoint® list.

16. A computer-readable medium having computer-executable instructions, which when executed perform steps, comprising, providing a portal for accessing media content, maintaining metadata associated with media content, managing the metadata at a content management system, and synchronizing changes to the metadata with the content, including when the content is maintained at an external data source, to manage the content at the content management system without maintaining the content for access at the content management system.

17. The computer-readable medium of claim 16 wherein managing the metadata at the content management system comprises providing a Microsoft® SharePoint® user interface that accesses a Microsoft® SharePoint® data structure.

18. The computer-readable medium of claim 16 wherein synchronizing the changes comprises providing a notification to the external data source.

19. The computer-readable medium of claim 16 having further computer-executable instructions comprising, creating a new event, and initiating a workflow corresponding to the event.

20. The computer-readable medium of claim 16 having further computer-executable instructions comprising, receiving data from the external data source, and generating a URL based on that data.
